(19) United States
(12) Patent Application Publication
(10) Pub. No.: US 2008/0217889 A1
(43) Pub. Date: Sep. 11, 2008

(54) Knee airbag

(75) Inventors: Carsten Rietz, Berlin (DE); Nick Eckert, Berlin (DE)

Correspondence Address: FOLEY AND LARDNER LLP;SUITE 500, 3000 K STREET NW, WASHINGTON, DC, 20007, US

(73) Assignee: Takata-Petri AG

(21) Appl. No.: 12/073,569

(22) Filed: Mar. 6, 2008

Related U.S. Application Data
(63) Continuation of application No. PCT/DE2006/001585, filed on Sep. 6, 2006.

(30) Foreign Application Priority Data
Sep. 7, 2005 (DE) 10 2005 043 308.1

(51) Int. Cl. B60R 21/20

(52) U.S. Cl. 280/730.1; 280/743.1

(57) ABSTRACT

An airbag for restraining a knee area of a vehicle occupant is formed by folding and joining the edges of a single-piece blank. The blank includes an airbag portion for inflation during deployment and at least one restraining strap portion joined to the airbag portion. The at least one restraining strap portion includes at least one additional part of the airbag that is defined as a restraining strap.

### CROSS-REFERENCE TO RELATED PATENT APPLICATIONS

This application is a Continuation of International Application PCT/DE2006/001585, filed Sep. 6, 2006, incorporated herein by reference in its entirety. This International Application was not published in English but was published in German as WO 2007/028376.

### BACKGROUND

The invention relates to an airbag, in particular for restraining the knee area of a vehicle occupant.

It is known to arrange restraining straps in airbags to provide the deployed airbag with a specific shape and/or in order to subdivide the airbag into a plurality of chambers.

### SUMMARY

One disclosed embodiment relates to an airbag for restraining a knee area of a vehicle occupant, the airbag being formed by folding and joining the edges of a single-piece blank. The blank includes an airbag portion for inflating during deployment and at least one restraining strap portion joined to the airbag portion. The at least one restraining strap portion includes at least one additional part of the airbag that is defined as a restraining strap.

Another embodiment relates to a method for assembling an airbag. The method includes the steps of spreading out a blank including an airbag portion for inflation during deployment and at least one restraining strap portion, joining a region of the restraining strap portion to the airbag portion, folding the restraining strap portion to define at least one restraining strap, folding back the airbag portion at least once, and joining the folded airbag portion to the unfolded airbag portion so the airbag can inflate in the region of the restraining strap.

### BRIEF DESCRIPTION OF THE DRAWINGS

The invention is to be explained in embodiments with reference to drawings, in which:

FIGS. 1A-1F show an airbag with a centrally arranged restraining strap in different phases of production according to an exemplary embodiment;

FIGS. 2A-2F show an airbag with two centrally arranged restraining straps; in different phases of production according to an exemplary embodiment;

FIGS. 3A-F shows an airbag with three restraining straps, of which two are arranged laterally and one restraining strap is centrally arranged, in different phases of production according to an exemplary embodiment;

FIGS. 4A-D show an inflation region having been formed according to an exemplary embodiment.

### DETAILED DESCRIPTION

According to one exemplary embodiment, an airbag may be configured for restraining the knee area of a vehicle occupant and be subdivided into two chambers by seams as described in DE 20 2004 014 653, which is herein incorporated by reference in its entirety. The airbag may be produced from a single blank. Opposing airbag portions are sewn together at the seam and no air cushion may be present in the seam region after deploying the airbag.

According to another exemplary embodiment, an airbag may include restraining straps for subdividing the airbag as described in EP0952043, which is herein incorporated by reference in its entirety. An air cushion is present near the straps or subdivisions after deploying the airbag. Each restraining strap is an additional component and additional operations may be required during the production of the airbag.

An object of the invention is to simplify the production of an airbag, in particular an airbag for restraining the knee area of a vehicle occupant.

An airbag (e.g., for restraining the knee area of a vehicle occupant) may be formed by folding and joining the edges of a single-piece blank. The blank includes at least one airbag portion for inflation during deployment that after joining represents at least one additional part of the airbag. Advantageously, the airbag incorporates what is typically an additional part into the single-piece blank and a separate blank and seams for the airbag are not needed. As a result, the production of the airbag may be more economical.

In one exemplary embodiment, the airbag includes a restraining strap as an additional part. The blank may include a restraining strap portion on one side with the width of the restraining strap portion smaller than the smallest width of the remaining piece of the blank material.

The blank may include a single restraining strap or a plurality of restraining straps. According to one exemplary embodiment, the restraining strap portion may be of a length that allows for a single restraining strap. The end of the restraining strap portion may be fastened to a position on the blank for the restraining strap. The end of the blank opposing the restraining strap portion may be folded back to form a loop and may be fastened to a region of the blank adjoining the restraining strap portion.

According to another exemplary embodiment, the restraining strap portion may be of a length that allows for two restraining straps. The airbag is constructed such that a central region of the restraining strap portion is fastened to positions on the air bag portion for the restraining straps. The end of the airbag portion opposing the restraining strap portion may be folded back to form a loop. An end of the restraining strap portion is joined to the folded-back part of the airbag portion to form the first restraining strap and an end of the air bag portion is fastened to a region of the airbag portion adjoining the restraining strap portion to form the second restraining strap.

According to other exemplary embodiments, the airbag may include a plurality of restraining straps. Each restraining strap may be formed from a different restraining strap portion and the blank may have at least one restraining strap portion on each of opposing sides. An airbag with three restraining straps may include a restraining strap portion on one side in a central region of the blank and on the opposing side two restraining strap portions in lateral regions of the blank.

The end of the restraining strap portion in the central region of the blank is fastened to a position on the blank for the restraining strap. The end of the airbag portion opposing the restraining strap portion is folded back to form a loop and is fastened to the region of the blank adjoining the restraining strap portion. The two restraining strap portions in the lateral region of the blank are fastened to a position of the blank for the restraining straps.

In a further exemplary embodiment, specifically for an airbag for restraining the knee area, the airbag may have turned-in portions. The folded edges of the turned-in portions may extend in the direction of the fastening regions.

According to another exemplary embodiment, the airbag may include an inflation region as an additional part.

The airbag portion of the blank for inflation during deployment and the portions that are additional parts may be rectangular to simplify production. Preferably, the airbag and the blank may include a woven fabric material.

A method for producing an airbag using a single blank may include the step of spreading out a blank that includes an airbag portion for inflation during deployment and that includes at least one restraining strap portion. The method also includes the steps of joining a region of the restraining strap portion to the airbag portion, folding back the airbag portion at least once, and joining the folded-back portion to the airbag portion in a region of the restraining strap.

According to various exemplary embodiments, the airbag may include a single restraining strap or a plurality of restraining straps. Each restraining strap may be formed from a different restraining strap portion. The blank may be folded back with the restraining strap portion located at one end. The end of the restraining strap portion is fastened to a position on the airbag portion for the restraining strap. The end of the blank opposing the restraining strap portion is also folded back and is fastened to a region of the blank adjoining the restraining strap portion.

According to an exemplary embodiment with two restraining straps, the blank with the restraining strap portion located at one end may be folded back to form a loop. The central region of the restraining strap portion may be fastened to positions on the blank for the restraining straps. The end of the blank opposing the restraining strap portion may also be folded back to form a loop. An end of the restraining strap portion may be joined to the folded-back part of the blank to form a first restraining strap. An end of the blank may be fastened to the region of the airbag portion adjoining the restraining strap portion to form the second restraining strap.

The blank may be turned in after sewing the restraining straps onto at least one side extending in the direction of the fastening regions. The ends of the blank extending perpendicular to the restraining strap longitudinal edges may be joined.

According to various exemplary embodiments all joins are preferably sewn.

The airbag according may be installed in a vehicle such that the join regions and the restraining straps extend transversely to a vehicle longitudinal axis after the airbag is deployed.

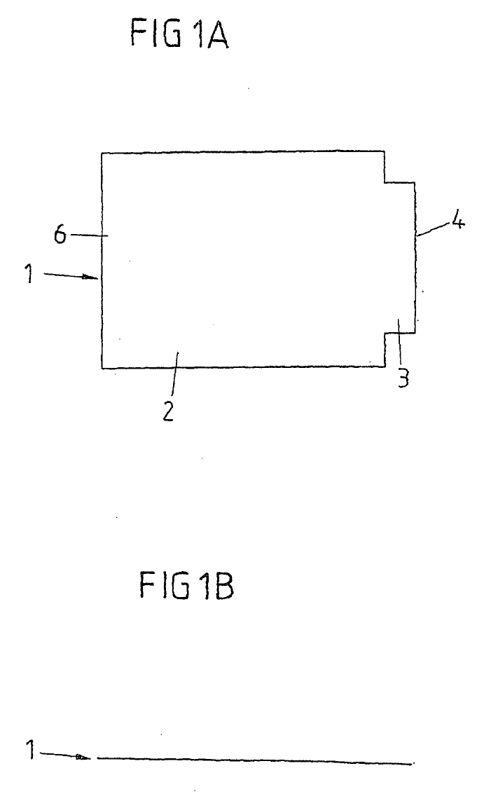

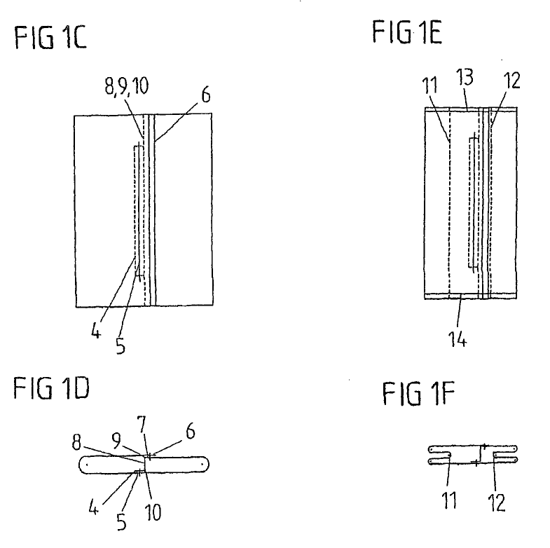

In FIG. 1a, a blank 1 for an airbag with a centrally arranged restraining strap is shown in a plan view according to an exemplary embodiment. The blank 1 includes an airbag portion 2 intended for inflation during deployment and a restraining strap portion 3 intended for the production of a restraining strap. The side view of FIG. 1b shows that the blank 1 is produced from a generally flat piece of material, for example from a piece of woven fabric. The restraining strap portion 3 forms one end of the blank 1 and is narrower than the airbag portion 2 so that the restraining strap (as shown in FIGS. 1c and 1e), does not extend over the entire width of the airbag. The restraining strap portion 2 is of a length allowing for the generally narrow restraining strap visible in FIGS. 1d and 1f.

At the start of production, the blank 1 with the restraining strap portion 3 is folded back and the end 4 of the restraining strap portion is fastened to a position 5 on an airbag portion for the restraining strap. Subsequently, the end 6 of the blank opposing the restraining strap portion 3 is also folded back and fastened to a region 7 of the airbag portion 2. The region 7 adjoins the restraining strap portion 3 as shown in FIGS. 1c and 1d. A narrow restraining strap 8 is produced that extends generally parallel to and between the fastening regions 5, 7.

The ends of the airbag extending parallel to the restraining strap 8 are turned in and folded edges 11, 12 extend generally parallel to the fastening regions 5, 7. The lateral edges of the airbag portion 2 located above one another are joined to one another by seams 13, 14 so that a complete airbag is assembled as shown in FIG. 1e.

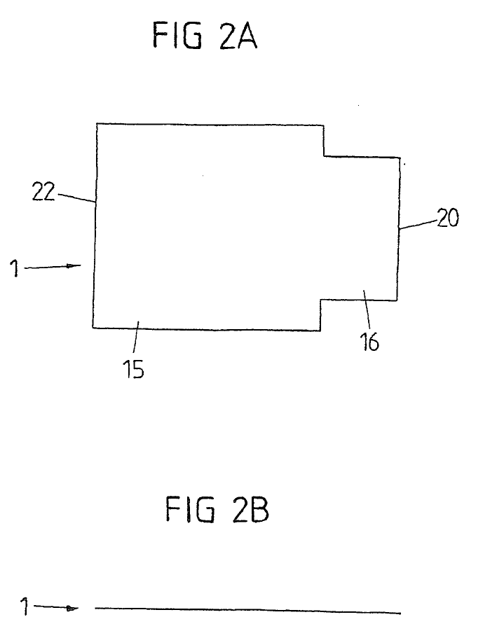

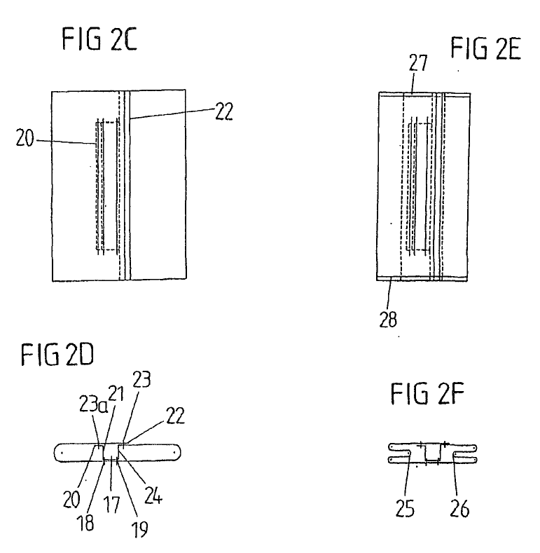

In FIG. 2a a blank 1 for an airbag with two centrally arranged restraining straps is shown in plan view according to an exemplary embodiment. The blank 1 includes an airbag portion 15 and a restraining strap portion 16. The side view of FIG. 2b shows that the blank is produced from a generally flat piece of material, for example from a piece of woven fabric. The restraining strap portion 16 forms an end of the blank 1 and is narrower than the airbag portion 15 so that the restraining straps (as shown FIGS. 2c and 2e) do not extend over the entire width of the airbag. The restraining strap portion 16 is of a length that allows for two generally narrow restraining straps as shown in FIGS. 2d and 2f.

To form two restraining straps, the blank 1 with the restraining strap portion 16 located at one end is folded back to form a loop. Subsequently, a central region 17 of the restraining strap portion 16 is fastened to positions 18, 19 on the airbag portion 15 for the restraining straps. An end 22 of the blank 1 opposing the restraining strap portion 16 is also folded back to form a loop. An end 20 of the restraining strap portion 16 is joined to the folded-back part of the airbag portion 15 in a region 23a to form a first restraining strap 21. The end 22 of the airbag portion 15 is fastened to the region 23 of the airbag portion 15 adjoining the restraining strap portion 16 to form a second restraining strap 24.

The ends of the airbag extending parallel to the restraining straps 21, 24 are turned in such that folded edges 25, 26 extend generally parallel to the fastening regions 18, 19, 23, 23a. The lateral edges of the airbag portion 15 located above one another are joined together by seams 27, 28 assembling a complete airbag as shown in FIG. 2e.

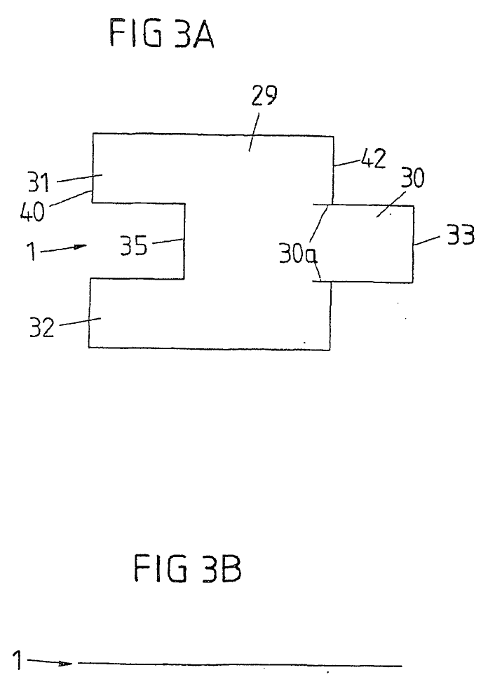

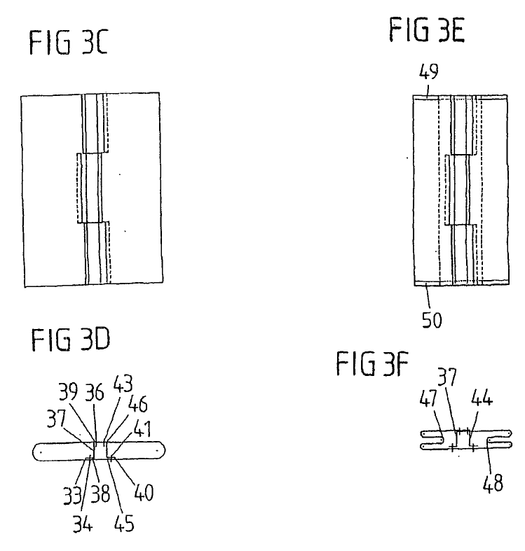

In FIG. 3a a blank 1 for an airbag is shown in plan view according to an exemplary embodiment with a restraining strap in a central region and two restraining straps in a lateral region. The blank 1 includes an airbag portion 29, a restraining strap portion 30 in the central region with slots 30a, and two restraining strap portions 31, 32 in lateral regions.

At the start of production, the blank with the restraining strap portion 30 is folded back as far as the region of the slots 30a and an end 33 of the restraining strap portion 30 is fastened to a position 34 on the airbag portion 29 for the restraining strap. An end 35 of the blank opposing the restraining strap portion 30 is folded back together with the lateral restraining strap portions 31, 32. The lateral restraining strap portions 31, 32, and the restraining strap portion 30 are guided into the interior of the airbag. The end 35 of the blank 1 and the adjoining regions of the airbag portion 29 are fastened to a region 36 of the airbag portion 29 adjoining the restraining strap portion 30 and the ends of the restraining strap portions 31, 32. A narrow central restraining strap 37 is produced that extends generally parallel to and between the fastening regions 34, 36.

The restraining strap portions 31, 32 are fastened with ends 40 to a region 41 of the airbag portion 29 to form the laterally arranged restraining straps. The overlapping airbag layers are joined together on a region 43 extending parallel to the region 36. Two narrow lateral restraining straps 44 are produced that extend generally parallel to and between the fastening regions 41, 43.

The ends of the airbag that extend parallel to the restraining straps 37, 44 are turned in such that folded edges 47, 48 extend generally parallel to the fastening regions 34, 36, 41, 43. The lateral edges of the airbag portion 29 located above one another are joined together by seams 49, 50 assembling a complete airbag as shown in FIG. 3e.

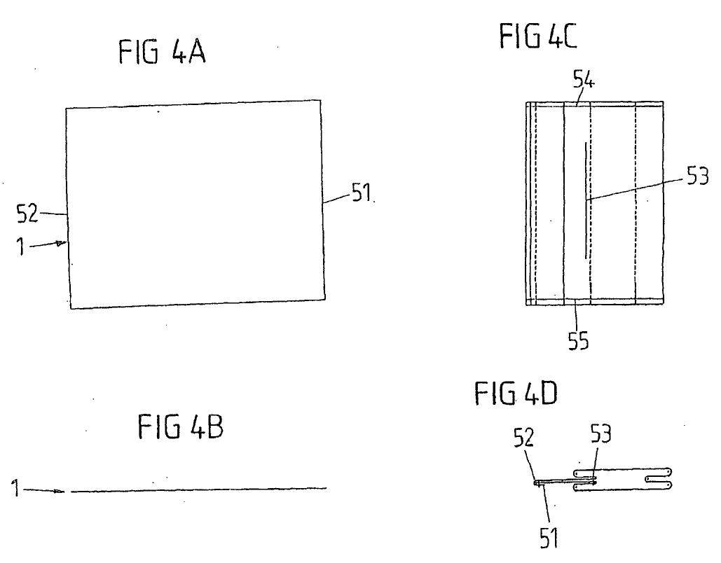

In FIG. 4a a blank 1 for an airbag is shown according to an exemplary embodiment in which an airbag with an inflation region is produced from the generally rectangular blank 1. One end 51 of the blank 1 is folded back so that it projects over an opposing end 52. The end 51 is folded back and sewn to the end 52 as shown in FIG. 4d. The folded-back parts of the blank 1 are joined together in a pre-determined portion by a seam 53. As shown in FIG. 4c, the seam does not extend over the entire width of the airbag; the seam does not subdivide the airbag into two chambers that are separate from one another.

The opposing ends parallel to the seam 53 are turned in and the lateral edges located above one another are joined together by seams 54, 55 forming a complete airbag as shown in FIG. 4c.

Germany Priority Application 10 2005 043 308.1, filed Sep. 7, 2005 including the specification, drawings, claims and abstract, is incorporated herein by reference in its entirety.

Given the disclosure of the application, one versed in the art would appreciate that there may be other embodiments and modifications within the scope and spirit of the application. Accordingly, all modifications attainable by one versed in the art from the present disclosure within the scope and spirit of the present application are to be included as further embodiments of the present application. The scope of the present application is to be defined as set forth in the following claims.

What is claimed is:

1. An airbag for restraining a knee area of a vehicle occupant, the airbag being formed by folding and joining the edges of a single-piece blank, wherein the blank comprises:
an airbag portion for inflating during deployment and
at least one restraining strap portion joined to the airbag portion,
wherein the at least one restraining strap portion comprises at least one additional part of the airbag, the additional part being defined as a restraining strap.

2. The airbag as claimed in claim 1, wherein the restraining strap portion is on one side of the blank, the width of the restraining strap portion being smaller than the smallest width of the rest of the blank.

3. The airbag as claimed in claim 2, wherein the restraining strap portion is of a length that allows a single restraining strap.

4. The airbag as claimed in claim 2, wherein an end of the restraining strap portion is fastened to a position on the blank and another end of the blank opposite the restraining strap portion is folded back to form a loop and is fastened to a region of the airbag portion adjoining the restraining strap portion.

5. The airbag as claimed in claim 2, wherein the restraining strap portion is of a length that allows two restraining straps.

6. The airbag as claimed in claim 5, wherein a central region of the restraining strap portion is fastened to positions on the airbag portion,
wherein an end of the airbag portion opposite the second portion is folded back to form a loop,
wherein an end of the restraining strap portion is joined to the folded-back end of the airbag portion to form the first restraining strap, and
wherein the folded-back end of the airbag portion is fastened to a region of the airbag portion adjoining the restraining strap portion to form the second restraining strap.

7. The airbag as claimed in claim 1, wherein the blank comprises a plurality of restraining straps, wherein each restraining strap is formed from a different restraining strap portion.

8. The airbag as claimed in claim 7, wherein the blank comprises at least one restraining strap portion on each of opposing sides.

9. The airbag as claimed in claim 8, wherein the blank comprises on one side a restraining strap portion in a central region of the blank and on the opposing side two restraining strap portions in lateral regions of the blank.

10. The airbag as claimed in claim 9, wherein an end of the restraining strap portion in the central region of the blank is fastened to a position on the airbag portion,
wherein another end of the airbag portion opposing the restraining strap portion is folded back to form a loop and is fastened to a region of the airbag portion adjoining the restraining strap portion, and
wherein the two restraining strap portions in the lateral region of the blank are fastened to a position of the airbag portion.

11. The airbag as claimed in claim 1, further comprising turned-in portions, wherein folded edges of the turned-in portions extend in the direction of fastening regions.

12. The airbag as claimed in claim 1, wherein the airbag portion and the restraining portion are rectangular.

13. The airbag as claimed in claim 1, wherein the blank comprises a woven fabric material.

14. A method for assembling an airbag, comprising the steps of:
spreading out a blank comprising an airbag portion for inflating during deployment and at least one restraining strap portion,
joining a region of the restraining strap portion to the airbag portion,
folding the restraining strap portion to define at least one restraining strap,
folding back the airbag portion at least once, and
joining the folded airbag portion to the unfolded airbag portion so the airbag can inflate in the region of the restraining strap.

15. The method as claimed in claim 14, wherein to form a single restraining strap the blank is folded back with the restraining strap portion located at one end, the end of the restraining strap portion is fastened to a position on the airbag portion, and the end of the blank opposing the restraining strap portion is folded back and fastened to a region of the airbag portion adjoining the restraining strap portion.

16. The method as claimed in claim 14, wherein to form two restraining straps the blank with the restraining strap portion located at one end is folded back to form a loop, a central region of the restraining strap portion is fastened to positions on the airbag portion, the end of the blank opposing the restraining strap portion is folded back to form a loop, the end of the restraining strap portion is joined to the folded airbag portion to form a first restraining strap, and the end of the airbag portion is fastened to a region of the airbag portion adjoining the restraining strap portion to form a second restraining strap.

17. The method as claimed in claims 14, wherein the blank is turned in after sewing the restraining straps onto at least one side that extends in the direction of fastening regions joining the ends of the blank extending perpendicular to the restraining strap longitudinal edges.

18. The method as claimed in claim 14, wherein all joins are sewn.
